(19) United States
(12) Patent Application Publication
(10) Pub. No.: US 2017/0279216 A1
(43) Pub. Date: Sep. 28, 2017

(54) CONNECTION BETWEEN AN ELECTRICAL CABLE AND A BUS BAR

(71) Applicant: ZF Friedrichshafen AG, Friedrichshafen (DE)

(72) Inventor: Hermann Thurn, Eckersdorf (DE)

(73) Assignee: ZF Friedrichshafen AG, Friedrichshafen (DE)

(21) Appl. No.: 15/505,539

(22) PCT Filed: Jul. 22, 2015
(86) PCT No.: PCT/EP2015/066694

§ 371 Date: Feb. 21, 2017

(30) Foreign Application Priority Data
Aug. 22, 2014 (DE) 10 2014 216 762.0

(51) Int. Cl. H01R 13/52; H01R 11/12; H01R 4/34

(52) U.S. Cl. CPC H01R 13/5202; H01R 13/5219; H01R 4/34; H01R 11/12

(57) ABSTRACT

The present disclosure provides an arrangement for connecting an electrical cable and a bus bar, where the bus bar includes an insulation device, and wherein the electrical cable includes a cable shoe attached an extruded body. The arrangement may include a connecting device, where the connecting device electrically connects the cable shoe of the electrical cable with the bus bar. The arrangement may further include a first sealing ring, where the first sealing ring is located between the extruded body of the cable shoe and the insulation device connected to the bus bar. The arrangement may further include a cap, where the cap seals the connecting device within the extruded body of the cable shoe.

The present disclosure refers to a connection between an electrical cable and a bus bar.

In drive units for motor vehicles with combustion-electrical drives, circuit boards are used for the controlling and regulating of the electrical drive. These circuit boards are usually positioned in close proximity of the electrical drive within the associated control unit. This position requires a corresponding arrangement for the power supply. Such a supply arrangement basically consists of a bus bar (which also may be referred to as a conductor rail), which is connected to the circuit board on one end. The other end of the circuit board is connected to an electrical cable, which connects the bus bar with the power supply.

In order to prevent damages of the connection point between the bus bar and the electrical cable due to moisture or environmental influences, it may be required to provide a connection between the bus bar and the electrical cable that is tightly sealed.

This objective is realized by means of the connection according to the characteristics of the independent claims. Further advantageous embodiments of the disclosure can be derived from the description, the patent claims and the drawing.

The connection between an electrical cable and a bus bar is characterized in that the bus bar features a plastic insulation device. The electrical cable furthermore features a cable shoe with an extruded body made of a plastic material on one end.

The connection features a connecting device, which connects the cable shoe of the electrical cable with the bus bar. By means of the connecting device, e.g. a screw, an electrical and mechanical force-fitting connection is established between the cable shoe and the bus bar.

A circulating first sealing is provided between the extruded body of the cable shoe and the plastic insulation device of the bus bar. This ensures that no moisture can reach between the bus bar and the connecting device.

Also, the connection is also characterized by a cap. This cap is arranged on the connecting device and the extruded body of the cable shoe and seals the connecting device within the extruded body of the cable shoe.

In one embodiment of the disclosure, a power jack is provided. The power jack is arranged between the bus bar and the cable shoe. The power jack is suitably made of an electrically conducting material and presents an electrical connection between the cable shoe and the bus bar. The power jack is suitably formed in a ring-shape, in such a way that the connecting device can be lead through the power jack. The extruded body of the cable shoe is suitably designed in such a way that the extruded body of the cable shoe includes an additional extruded body of at least part of the power jack.

In one embodiment of the disclosure, a circulating second sealing is arranged between the cap and the extruded body of the cable shoe. This ensures that no moisture can reach into the space between the connecting device and the cable shoe extruded body.

In one embodiment of the disclosure, the bus bar comprises a mounting fixture for the connecting device. This mounting fixture is hereby enclosed by the plastic insulation device. In the case that the connecting device is e.g. a screw, the mounting fixture can be a thread that is arranged within the bus bar. But it is also possible that the bus bar comprises a through hole, into which a threat element can be inserted. The screw, which serves as the connecting device, can fit into this thread insert and can thus produce a reliable connection between the cable shoe and the bus bar.

In the following, certain embodiments of the disclosure is described in more detail by means of figures. It is shown:

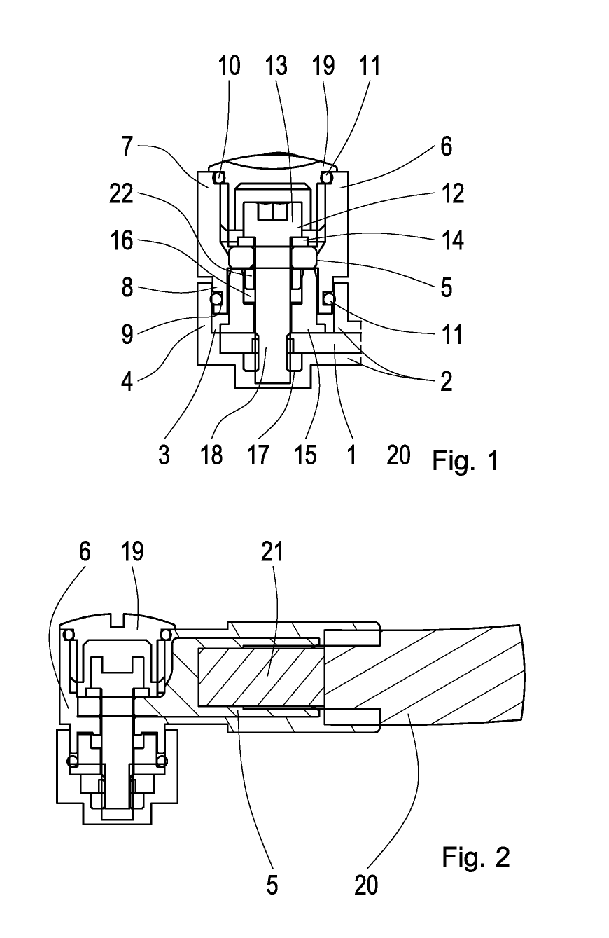

FIG. 1 in cross section a schematic first depiction of a connection according to the disclosure between an electrical cable and a bus bar,

FIG. 2 in cross section, a schematic second depiction of a connection according to the disclosure, between an electrical cable and a bus bar.

FIG. 1 shows the connection between a bus bar 1 and a cable shoe 5, which is attached to an electrical cable 20. Cable shoe 5 is connected to bus bar 1 by means of a screw 12. For this reason, bus bar 1 features a through hole 18, into which a thread element 17 is inserted. Screw 12 fits into thread insert 17 and can thus press cable shoe 5 into the direction of bus bar 1 and thereby produce an electrical and mechanical connection between cable shoe 5 and bus bar 1.

Bus bar 1 comprises a plastic insulation device 2. This plastic insulation device 2 also encloses the thread insert 17. This plastic insulation device 2 of bus bar 1 comprises a cavity 3 on the side of bus bar 1 that is facing towards cable shoe 5, in which there is no plastic insulation device 2. The purpose of cavity 3 is to connect cable shoe 5 with bus bar 1. Plastic insulation device 2 features a ring-shaped ridge 4, which runs around this cavity 3.

A power jack 15 is arranged within this cavity 3. Power jack 15 is designed in a basically ring-shaped manner. Screw 12 runs through power jack 15 in axial direction.

Strand 21 of the electrical cable 20 is attached to a cable shoe 5. This cable shoe 5 features an extruded body 6 that is made of a thermoplastic, a thermoplastic elastomer, or a thermoset material. This extruded body 6 is designed in such a way that it features a circulating ridge 7 on the side that is facing towards the bus bar. The purpose of this circulating ridge 7 is to receive power jack 15. At the same time, this circulating ridge also engages into the circulating ridge 4 of the plastic insulation device 2 of bus bar 1.

On the side that is facing away from the bus bar, extruded body 6 of cable shoe 5 features a further circulating ridge 8. The purpose of this ridge 8 is to receive screw head 13 of screw 12. The height of ridge 8 is particularly higher than the height of screw head 13.

Ridge 8 of the cable shoe extruded body 6, which is facing away from the bus bar, comprises an inner thread. A cap 19 is screwed into this inner thread. This cap 19 is resting on ridge 8 of the cable shoe extruded body 6, which is facing away from the bus bar, and thus seals screw 12 against moisture. But it is also possible that the cap 19 is pressed into the space that is created by ridge 8, which is facing away from the bus bar.

Ridge 8 of the cable shoe extruded body 6, which is facing away from the bus bar, comprises a circulating recess 10 on the inside. A sealing ring 11 is inserted into this recess 10. This sealing ring 11 is arranged between cable shoe extruded body 6 and cap 19. This improves the sealing effect of cap 19.

Ridge 7 of the cable shoe extruded body 6, which is facing towards the bus bar, features a circulating recess 9 on the outer side. A sealing ring 11 is inserted into this recess 9. This sealing ring 11 is arranged between cable shoe extruded body 6 and the plastic insulation device 2 of bus bar 1, in particular of ridge 4 of the plastic insulation device 2. This prevents that moisture can reach into the space between cable shoe extruded body 6 and bus bar 1.

A washer 14 is arranged between cable shoe 5 and screw 12. This washer 14 features a section 22, which reaches through cable shoe 5. A recess 16 is thus provided in power jack 15, which radially encloses and retains part 22 of washer 14, which reaches through cable shoe 5. Part 22 of washer 14, which reaches through cable shoe 5 ends within recess 16 of power jack 15.

In FIG. 2, a connection according to the descriptions in FIG. 1 is depicted. Additionally, an electrical cable 20 can be seen in FIG. 2. The electrical cable 20 comprises a strand 21, which is attached to cable shoe 5.

### REFERENCE SIGNS

1 Bus bar
2 Plastic insulation device
3 Cavity in the plastic insolation device
4 Ridge around the cavity
5 Cable shoe
6 Cable shoe extruded body
7 Ridge of the cable shoe extruded body that is facing towards the conductor rail
8 Ridge of the cable shoe extruded body that is facing away from the conductor rail
9 Recess in the ridge of the cable shoe extruded body that is facing towards the conductor rail
10 Recess in the ridge of the cable shoe extruded body that is facing away from the conductor rail
11 Sealing ring
12 Screw
13 Screw head
14 Washer
15 Power jack
16 Recess in the power jack
17 Thread insert
18 Recess in the conductor rail
19 Cap
20 Electrical cable
21 Stand
22 Section of the washer

1. An arrangement for connecting an electrical cable and a bus bar, wherein the bus bar comprises a insulation device, and wherein the electrical cable comprises a cable shoe attached an extruded body, the arrangement comprising:
a connecting device, wherein the connecting device electrically connects the cable shoe of the electrical cable with the bus bar; and
a first sealing ring, wherein the first sealing ring is located between the extruded body of the cable shoe and the insulation device connected to the bus bar; and
a cap, wherein the cap seals the connecting device within the extruded body of the cable shoe.

2. The arrangement of claim 1, further comprising an electrically conducting power jack, wherein the electrically conducting power jack is connected to the bus bar and the cable shoe, and wherein the power jack is configured to receive the connecting device.

3. The arrangement of claim 1, further comprising a second sealing ring located between the cap and the extruded body of the cable shoe.

4. The arrangement of claim 1, wherein the bus bar includes a mounting fixture for receiving the connecting device, and wherein the mounting fixture is enclosed by the insulation device.

5. The arrangement of claim 1, wherein the insulation device is formed by a plastic material.

6. The arrangement of claim 1, wherein the extruded body comprises at least one of a thermoplastic, a thermoplastic elastomer, or a thermoset material.

7. An arrangement for connecting a bus bar and an electric cable, the arrangement comprising:
an extruded body configured to connect to a cable shoe, wherein the extruded body includes a hole for receiving a connecting device, and where the extruded body includes a ridge;
an insulation device configured to receive the bus bar, wherein the insulation device includes a cavity configured to receive the ridge of the extruded body; and
the connection device, wherein the connection device is configured to extend through the hole of the extruded body and into the cavity of the insulation device, the connecting device including an electrically conductive body.

8. The arrangement of claim 7, further comprising an electrically conducting power jack, wherein the electrically conducting power jack is connected to the bus bar and the cable shoe, and wherein the power jack is configured to receive the connecting device.

9. The arrangement of claim 7, further comprising a first sealing ring, wherein the first sealing ring is located between the extruded body of the cable shoe and the insulation device connected of the bus bar.

10. The arrangement of claim 9, further comprising a second sealing ring located between a cap and the extruded body of the cable shoe.

11. The arrangement of claim 7, wherein the bus bar includes a mounting fixture for receiving the connecting device, and wherein the mounting fixture is enclosed by the insulation device.

12. The arrangement of claim 7, wherein the insulation device is formed by a plastic material.

13. The arrangement of claim 7, wherein the extruded body comprises at least one of a thermoplastic, a thermoplastic elastomer, or a thermoset material.

14. The arrangement of claim 7, further comprising a cap that seals the connecting device within the extruded body of the cable shoe.

15. A method for connecting an electrical cable and a bus bar, wherein the bus bar comprises a insulation device, and wherein the electrical cable comprises a cable shoe attached an extruded body, the method comprising:
connecting the cable shoe of the electrical cable with the bus bar with a connecting device, wherein a first sealing ring is located between the extruded body of the cable shoe and the insulation device connected to the bus bar; and
connecting a cap to the extruded body, wherein the cap seals the connecting device within the extruded body of the cable shoe.

16. The method of claim 15, further comprising connecting the bus bar to a power jack, wherein the power jack is configured to receive the connecting device.

17. The method of claim 15, further comprising locating a second sealing ring between the cap and the extruded body of the cable shoe.

18. The method of claim 15, wherein the bus bar includes a mounting fixture for receiving the connecting device, and the method further comprising enclosing the mounting fixture by the insulation device.

19. The method of claim 15, wherein the insulation device is formed by a plastic material.

20. The method of claim 15, wherein the extruded body comprises at least one of a thermoplastic, a thermoplastic elastomer, or a thermoset material.
